(19) United States
(12) Patent Application Publication
(10) Pub. No.: US 2008/0116240 A1
(43) Pub. Date: May 22, 2008

(54) Method and apparatus for fracturing seal rings

(76) Inventor: Mark Stephen Edwards, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/011,056

(22) Filed: Jan. 23, 2008

Related U.S. Application Data
(63) Continuation-in-part of application No. 11/014,008, filed on Dec. 16, 2004.
(60) Provisional application No. 60/531,711, filed on Dec. 22, 2003.

(51) Int. Cl. B26F 3/02

(52) U.S. Cl. 225/1; 225/103

(57) ABSTRACT

An apparatus and method for fracturing a seal ring for use in applications in which the seal prevents or reduces leakage. The present invention discloses a retaining recessed pocket used to hold the unfractured sealing ring in place during fracturing contact with the fracturing pin.

### CROSS-REFERENCE TO RELATED APPLICATION

This application claims the benefit of U.S. Provisional Application No. 60/531,711, filed Dec. 22, 2003 and U.S. patent application Ser. No. 11/014,008, filed Dec. 16, 2004.

### FIELD OF THE INVENTION

The present invention relates to seal rings. More particularly, the present invention relates to a method and apparatus for fracturing a seal ring to perform a sealing function.

### BACKGROUND OF THE INVENTION

As is generally known, seal rings have been made out of various materials, most commonly made from metals such as cast iron, flexible elastomers, and various polymers. Since the seal ring is placed in a groove of a piston or shaft, a gap must be placed in a non-elastic ring so as to facilitate application of and removal of the seal ring from the piston or shaft. Some applications for these seal rings are compressors, pumps, automatic transmissions and power steering devices. The known methods for preparing gaps in these rings have been to machine in the case of metals and polymers and to cut in the case of flexible polymers. Both machining and cutting of such rings has been both tedious and labor intensive, resulting in higher part manufacturing costs.

The following disclosures may be relevant to various aspects of the present invention and may be briefly summarized as follows:

U.S. Pat. No. 5,988,649 to Van Ryper et al. discloses a seal ring having a fracture line through its thickness to form opposing faces. The faces are rough and mesh together such that when the faces are forced into contact, the faces are then interlocked. The fracture line of the seal ring is made by a device that has a support means of two support pins and a pressing means of a third pin. The two support pins support the seal ring along the seal rings inner circumference at two places, which are spaced some distance apart, resulting in an unsupported region of the seal ring. The pressing means of the third pin is then applied tangentially at an unsupported region of the outer surface of the seal ring, substantially opposite and generally equidistant between the two places, sufficient to create the fracture line of the seal ring. This method of fracturing rings uses several parts, has the potential for extended change over time and may cause unwanted stress on the seal ring being fractured causing undesirable side affects such as secondary fractures.

It is desirable to have a simpler and more efficient method of fracturing a seal ring without sacrificing sealing quality. It is further desirable to reduce unwanted stress on the seal ring being fractured and to reduce extended change over time of the fracturing seal ring apparatus.

### SUMMARY OF THE INVENTION

Briefly stated, and in accordance with one aspect of the present invention, there is provided a process for fracturing a seal ring comprising: holding said seal ring having a circumference in a horizontal recessed area of a holding member, restricting the outward deflection of said circumference, said seal ring being loosely held in said horizontal recessed area; compressing a singular localized point on said circumference of said seal ring inwardly with a fracturing member; accumulating sufficient force with the front of the fracturing member to deflect sharply inward the localized point of the seal ring circumference, until said force overstresses said seal ring, and said fracturing member, in contact with said circumference of said seal ring, fractures the seal ring.

In one embodiment, the process for fracturing a seal ring comprises:

a) placing the seal ring having a circumference in a horizontal recessed area of a holding member, wherein the horizontal recessed area has a depth (h) thereby providing a wall having a height equal to depth (h) surrounding the horizontal recessed area and wherein the wall restricts the outward deflection of the circumference, the seal ring is loosely held in the horizontal recessed area and the weight of the seal ring is supported by the horizontal recessed area, whereby said horizontal recessed area and said wall provide three-dimensional support and constraint for said seal ring; and

b) deflecting sharply radially inward a singular localized point on the circumference of the seal ring with a fracturing member, thereby deflecting sharply inward a portion of the seal ring until the force applied by the fracturing member overstresses the seal ring and the fracturing member fractures said seal ring.

Pursuant to another aspect of the present invention, there is provided an apparatus for fracturing a seal ring comprising: a holding member with a horizontal recessed area for loosely holding the seal ring having a circumference, restricting outward deflection of said circumference; a fracturing member, wherein said fracturing member compresses the seal ring in the horizontal recessed area, deflecting sharply inward the seal ring until the fracturing member fractures the seal ring.

In one embodiment the apparatus for fracturing a seal ring comprises:

a) a holding member containing a horizontal recessed area with a depth (h) thereby providing a wall of that height equal to depth (h) surrounding the horizontal recessed area, wherein the seal ring with a circumference, an outside diameter (d) and a thickness (t) is held within and its weight is supported, by the horizontal recessed area and wherein outward deflection of the circumference of the seal ring is restricted by the wall, whereby the horizontal recessed area and the wall provide three-dimensional support and constraint for the seal ring; and

b) a fracturing member, wherein the fracturing member is positioned to deflect sharply inward a portion of the seal ring and thereby fracture the seal ring.

### BRIEF DESCRIPTION OF THE DRAWINGS

The invention will be more fully understood from the following detailed description, taken in connection with the accompanying drawings, in which:

FIG. 1A is a schematic view of an embodiment of the apparatus for fracturing a seal ring showing the seal ring in a circular horizontal recessed area.

FIG. 1B is a schematic view of the embodiment of FIG. 1A showing the fracturing member deflecting inward a portion of the seal ring in a circular horizontal recessed area.

FIG. 1C is a cross-sectional view of FIG. 1A showing the height h of the wall surrounding the horizontal recessed area and the thickness t of the seal ring.

FIG. 2 shows a side view of the fractured seal ring of the present invention with the top view showing the seal ring separated at the fracture and the second view showing the fractured seal ring closed.

FIG. 3 is a cross-sectional view of the seal ring positioned within a radial groove of a cylindrical member to perform a sealing function when the cylindrical member is positioned within a bore of a housing.

FIG. 4 is an enlarged view of an embodiment of the fracturing tip and support member of the fracturing member of FIG. 1A.

FIG. 5A is a schematic view of another embodiment of the present invention in which the horizontal recessed area includes a portion having a “V” shape.

FIG. 5B is a schematic view of the embodiment of FIG. 5A showing the fracturing member deflecting inward a portion of the seal ring in the “V”-shaped portion of the horizontal recessed area.

FIG. 5C, is a cross-section of FIG. 5A taken through the points of contact of the seal ring and the wall surrounding the horizontal recessed area and shows the height h of the wall surrounding the horizontal recessed area and the thickness t of the seal ring.

FIG. 6 is an enlarged view of the fracturing tip and support member of the fracturing member of the embodiment of FIG. 5A.

FIG. 7 is a schematic diagram of the deflection of the seal ring by the fracturing member tip of FIG. 4.

FIG. 8A is a schematic view of the embodiment shown in FIG. 5A with a seal ring of smaller diameter than that shown in FIG. 5A.

FIG. 8B is a schematic view of the embodiment of FIG. 8A showing the fracturing member deflecting inward the seal ring in the “V”-shaped portion of the horizontal recessed area. While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

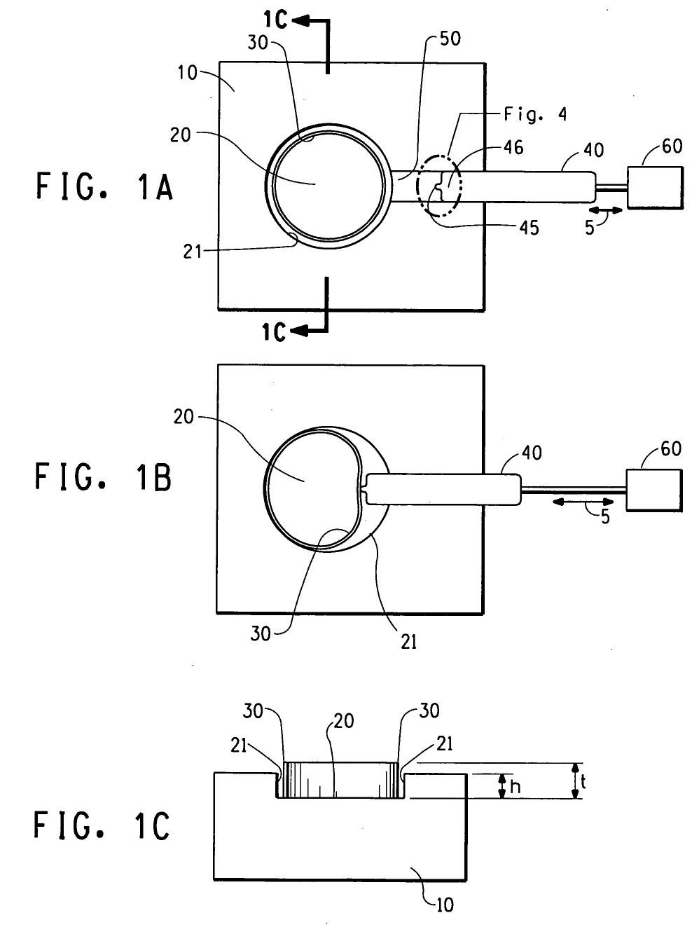

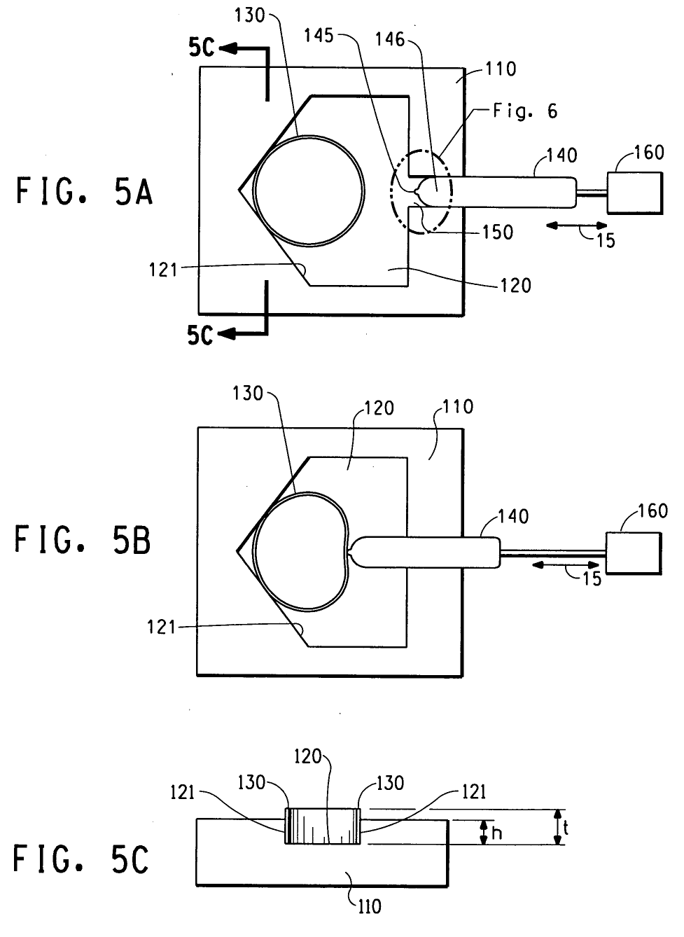

The present invention provides a method of fracturing a seal ring that is simple and efficient without decreasing the seal ring's ability to prevent or minimize leakage. While it is desirable to eliminate leakage entirely, it is recognized that due to temperature or certain applications minimal leakage is acceptable in the present invention as will be apparent to those of skill in the art. The method of the present invention loosely holds a seal ring in a recessed area of a holding member, i.e., a retaining pocket, which is preferably circular or round (see FIG. 1A or 1B) or angular or “V” shaped (see FIG. 5A, 5B, 8A or 8B) to restrict the outward deflection of the seal ring circumference when a localized point on the circumference of the seal ring is compressed inward by a fracturing member. As this force builds or accumulates, the seal ring area in front of the fracturing member is deflected sharply inward (due to the constraints of the retaining pocket on the remainder of the seal ring) until the seal ring is over-stressed and fractures at the contact with the fracturing member.

Reference is now made to the drawings for a detailed description of the present invention. FIG. 1A discloses a schematic of one embodiment of the apparatus of the present invention. A holding member, plate 10, having a retaining pocket, i.e., a horizontal recessed area, 20 loosely holds the sealing ring 30. The horizontal recessed area 20 has a depth h, thereby providing a wall 21 of height h surrounding the horizontal recessed area 20. The seal ring 30 is supported by the horizontal recessed area 20. The horizontal recessed area is preferably in the shape of the ring 30 (i.e., circular or round in shape as in FIGS. 1A and 1B) or in an angular or “V” shape (see FIG. 5A or 8A). A fracturing member 40 is guided radially inward to the seal ring 30 by any suitable means. One such means is a recessed channel 50 as shown by FIG. 1B.

FIG. 1B shows the fracturing member 40 deflecting sharply inward the seal ring 30. FIG. 1C is a cross-sectional view of FIG. 1A and shows the seal ring 30 situated on the horizontal recessed area 20 of the holding member 10 and the wall 21 surrounding the horizontal recessed area 20. Also shown are the height h of the wall 21 surrounding the horizontal recessed area 20 and the thickness t of the seal ring 30. The weight of the seal ring 30 is supported by the horizontal recessed area 20. As shown in FIG. 1B, the outward deflection of the circumference of seal ring 30 is restricted by the wall 21 surrounding the horizontal recessed area 20. Thus the horizontal recessed area 20 and the wall 21 provide three-dimensional support and constraint for the seal ring 30.

The fracturing member 40 has a fracturing tip 45 supported by a support member 46. An enlarged view of the fracturing tip and support member is shown in FIG. 4. The sliding direction of the fracturing member 40 for fracturing and retracting is shown by arrow 5. The fracturing member 40 contacts the circumference of the sealing ring 30. A mechanism such as an air cylinder 60 is used to provide the fracturing member with the compressive force to fracture the seal ring.

Reference is now made to FIGS. 5A, 5B, 8A and 8B. These Figures disclose a schematic view of another embodiment of the apparatus of the present invention. A holding member, plate 110, having a retaining pocket, i.e., a horizontal recessed area, 120 loosely holds the sealing ring 130. The horizontal recessed area 120 has a depth h, thereby providing a wall 121 of height h surrounding the horizontal recessed area 120. The seal ring 130 is supported by the horizontal recessed area 120. The horizontal recessed area 120 includes a portion that has a “V” shape. FIG. 8A shows the same embodiment with a smaller size seal ring 135. The “V” shape enables seal rings of different sizes (e.g., seal rings 130 and 135) to be used in the apparatus as they are positioned appropriately in the “V”-shaped portion of the horizontal recessed area as described below. A fracturing member 140 is guided radially inward to the seal ring by suitable means such as a recessed channel 150 as shown by FIG. 5B. FIG. 5B shows the fracturing member 140 deflecting sharply inward the seal ring 130. FIG. 5C is a cross-sectional view of FIG. 5A and shows the seal ring 130 situated on the horizontal recessed area 120 of the holding member 110 and the wall 121 surrounding the horizontal recessed area 120. FIG. 5C also shows the points of contact of the seal ring 130 and the wall 121 surrounding the horizontal recessed area 120. Also shown are the height h of the wall 121 and the thickness t of the seal ring 130. The weight of the seal ring 130 is supported by the horizontal recessed area 120. As shown in FIG. 5B, as the fracturing member 140 deflects the seal ring 130 inward, the region of contact between the seal ring 130 and the wall 121 increases and the outward deflection of the circumference of seal ring 130 is restricted by the wall 121 surrounding the horizontal recessed area 120. Thus the horizontal recessed area 120 and the wall 121 provide three-dimensional support and constraint for the seal ring 130.

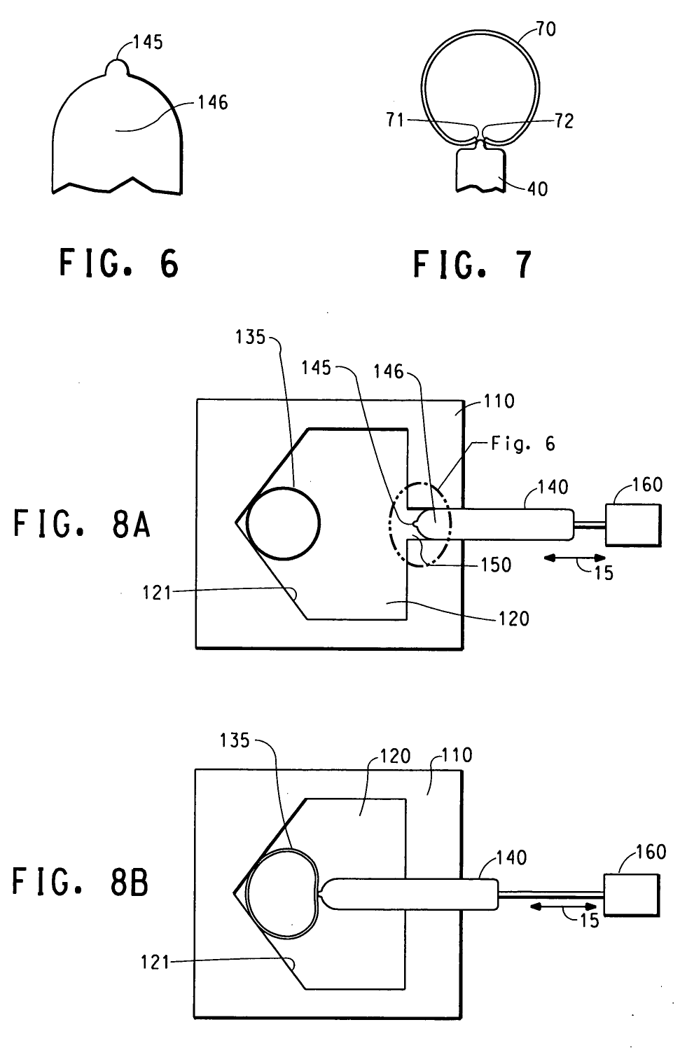

The fracturing member 140 has a fracturing tip 145 supported by a support member 146. An enlarged view of the fracturing tip and support member is shown in FIG. 6. The sliding direction of the fracturing member 140 for fracturing and retracting is shown by arrow 15. The fracturing member 140 contacts the circumference of the sealing ring 130 or 135. A mechanism such as an air cylinder 160 is used to provide the fracturing member with the compressive force sufficient to fracture the seal ring.

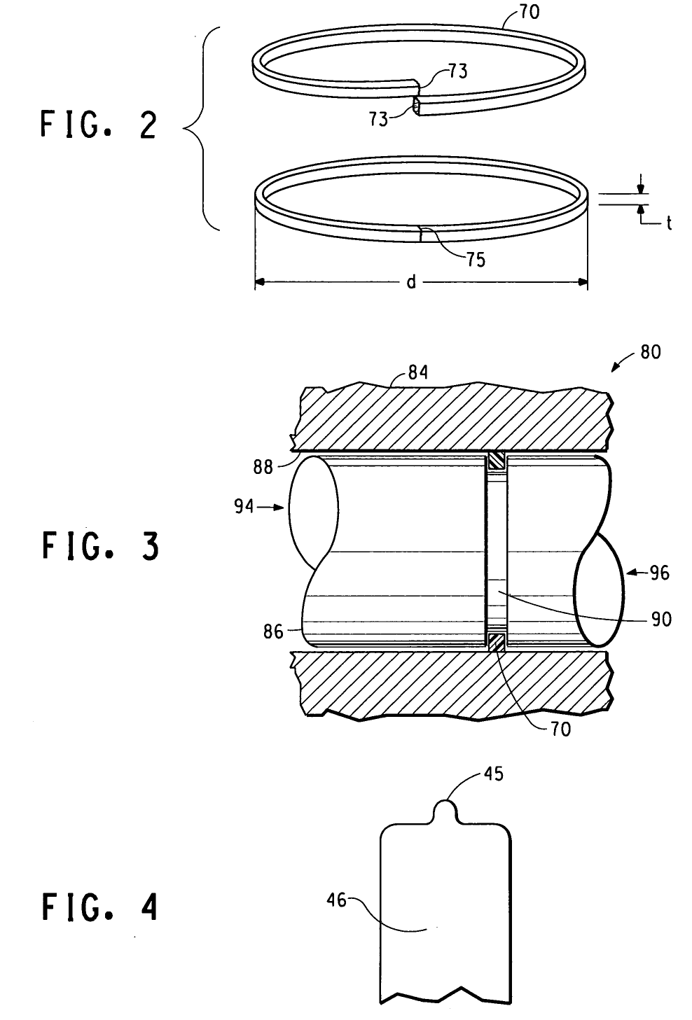

Reference is now made to FIG. 2, which shows the fractured seal ring 70 that occurs from the method of the present invention. The fracture line 75 of the sealing ring 70 consists of opposing faces 73, which are perpendicular to the circumference of the seal ring. That is, the fracture line essentially does not deviate at an angle to the radius. Additionally, the opposing faces 73 are rough, as naturally occurs by the fracture method of the present invention described above. FIG. 2 also shows the outside diameter (d) and the thickness (t) of the seal ring. With reference to FIG. 3, when the seal ring is placed within the radial groove 90 of the cylindrical member 86, then placed within the bore 88 of the housing 84, the opposing faces are in or near contact with each other.

As is generally known to those of ordinary skill in the art, the seal ring becomes heated during the rotational or reciprocating movement of the cylindrical member, which causes the seal ring to thermally expand when the seal assembly is at operating conditions. For that reason, the opposing faces may not necessarily make contact until the operating conditions are reached. Along with temperature, fluid pressure is another operating condition, which affects the seal rings ability to perform the sealing function. With continuing reference to FIG. 3, when operating pressure is achieved on the pressurized side 94 of the seal assembly 80, as described herein and the operating temperature is achieved, the opposing faces mesh and interlock, thereby closing the gap which was created for installation of the seal ring and whereby the gap does not become a point of leakage. It should be noted that due to the fact that the rough opposing faces mesh and interlock, a single seal ring is all that is required to perform the sealing function. In other words, more than one fractured seal rings, wherein the fracture lines are staggered in opposite directions, as has been common heretofore because of the inability of the gap to completely close, are not required to perform the sealing function. The fractured seal rings created by the method of the present invention can be used in a variety of applications including static, reciprocating and rotating applications to perform a sealing function. The sealing rings are used in applications where fluids in the form of liquid or gas are isolated, such that the fluid exerts pressure against the seal ring thereby creating a sealed surface.

FIG. 3 shows a known application for a seal assembly 80 in which a seal ring made from the present invention is disclosed. The assembly 80 is made up of a housing 84 and a cylindrical member 86 movably positioned within a bore 88 of the housing 84. The cylindrical member 86 moves within the bore 88, in either a reciprocating or rotating mode. The cylindrical member 86 has a radial groove 90 for seating a seal ring 70, such that the cylindrical member is positioned within the housing, and the seal ring performs a sealing function.

As may be expected, undesirable leakage of fluids across the seal ring would be evidence that the seal assembly 80 is not functioning properly. As mentioned above, in some instances complete removal of leakage is not possible. Furthermore, there are instances where small and controlled leakage is preferred. For example, a controlled leakage may be used for lubrication or heat removal for a bearing or bushing on the non-pressured side such as in a transmission. When the seal ring is positioned within the seal assembly 80 and upon pressurization of the seal assembly a properly functioning seal ring 70 will prevent, or at least minimize, leakage of fluids. The cylindrical member 86 has a pressurized side upstream of the seal ring indicated generally at 94 and a non-pressurized side downstream of the seal ring indicated generally at 96. The seal ring 70 functions by isolating the pressurized side 86 from the non-pressurized side 96.

In the apparatus and method of the present invention, the edge or fracturing tip 45 of the fracturing member 40 shown in FIGS. 1A and 1B can be sharper than the dowel or round pressing pin of the prior art (U.S. Pat. No. 5,988,649) and not score the seal ring surface. In the present invention, the preferred fracturing member tip or edge 45 is the shape of a dulled edge having a radius of preferably 0.015 inches to 0.050 inches. The support structure 46 behind the fracturing tip 45 can be triangular or oval shaped. The support structure behind the fracturing tip is preferably convexed as it allows the fractured ring end surfaces to avoid being scored upon fracture of the ring. The blunt convex or triangular support to the fracturing member tip prevents the fracturing tip from spreading the two fractured ring ends apart so as to allow the fracturing member assembly to pass between said ring ends. With the preferred blunt shape supporting the fracturing member tip, the fracture ring ends continue to be deflected inwardly. FIG. 7 shows the deflection of the fractured seal ring 70. As the fracture ring ends 71, 72 deflect inwardly they also curl back upon themselves thus further preventing contact of the fracture ring faces with the fracturing member 40. A triangular support, (not shown) can be used as an alternate embodiment to the blunt convex support, if the angle as measured from the tip is greater than 10 degrees, preferably greater than 30 degrees, and more preferably greater than 60 degrees.

In FIGS. 5A, 5B, 8A and 8B an alternate embodiment of the fracturing tip 145 and the support structure 146 are shown. Either of these fracturing tips and support structures can be used in either of the recessed area apparatus or methods of the present invention. A sharp “cutting” fracturing tip should be avoided since it may score, notch or etch the circumference of the ring such that undesirable leakage of the seal may result. This combination of geometry concentrates the stress to a preferred narrow zone prior to fracture using the small geometry tip and then prevents distortion of the matching fracture walls by lifting the fracture faces off the fracture member using the wider supporting structure behind the tip. It also permits the position of the fracture to be more precisely controlled since the stress zone has been significantly narrowed in comparison to the prior art.

The amount of force required to fracture the seal ring will vary with the material characteristics and cross section of the seal ring. The rate at which the force is applied to the seal ring is also important. If the force is applied too slowly the fracture line will propagate at an angle to the radius. Additionally, slow application of the force, along with hyperextension such that the fracturing member or other fracturing mechanism is moved too far toward the center of the seal ring, may result in deformation of the original round ring shape of the seal ring. If the seal ring is hyperextended, the local elastic limit of the material may be exceeded and the seal ring may deform. If, on the other hand, the force is applied too quickly, hyperextension may also occur resulting in deformation of the seal ring. For that reason, it is preferred that the rate of application of force to the seal ring be swift, rather than gradual and the stroke length of the fracturing member be limited. The force may be applied by hand pressure or by controlled mechanical means. The calculation of the amount of force to be applied for given parameters as indicated above is apparent to one of ordinary skill in the art.

The seal ring is partially constrained on its circumference by the wall surrounding the horizontal recessed area 20 while being inwardly deflected by the fracturing member. A circular or angular geometry is preferred for the pocket because of its self-centering characteristic. In the angular geometry (e.g. a “V”-shaped portion of the horizontal recessed area), the ring will migrate to the bottom of the “V” or furthest most tangential position from the fracturing member when displaced by the fracturing member. One is now assured of the position of the fracture relative to some ring characteristic such as a tab or oil grove. With a round pocket, seal rings from 75% of the diameter of the round pocket up to the diameter of the pocket can be fractured without changing the pocket size. Seal rings smaller in diameter than 75% of the pocket diameter may have a tendency to nest improperly at the farthest tangential point to the fracturing member and thus be poorly aligned. With a “V” type pocket this problem is overcome and it can be a universal holder for a wide range of diameters. See seal rings 135 and 130 shown in FIGS. 8A, 8B, 5A and 5B for two examples of how seal rings differing in size can be accommodated in the “V”-shaped retaining pocket of the present invention.

The recessed depth of the pocket for either the circular or the “V” shape is a matter of preference in the present invention. The depth need only be sufficient to prevent the seal ring from “jumping” the wall of the pocket caused by seal ring chamfers, beveled edges or other seal; ring characteristics that could initiate a lifting of the seal ring out of the pocket. The wall height or depth of the recessed pocket, i.e., the horizontal recessed area, is at least one half the thickness of the seal ring. For many seal rings having an outside diameter of four (4) inches or less, the depth is at least 0.05 inches in depth and most preferably at least 0.100 inches for many applications.

The prior art of U.S. Pat. No. 5,988,649 teaches a three pin method that has a significant limitation in comparison to the present invention. For very small diameter rings, there is insufficient internal open area of the seal ring to locate the two constraining pins and still have an unsupported region for the external pin to apply a force.

Using the apparatus of the present invention, as described above, according to the method of the present invention described above, results in a seal ring having true roundness, despite the presence of the fracture line therein, which is necessary to perform the sealing function. By “true roundness” is meant the seal's ability to maintain a round form even after the seal has been fractured. In ANSI Y14.5M-1982, true roundness is further defined in that all points of the surface intersected by any plane perpendicular to a common axis are essentially equidistant from that axis. If the seal ring is “out of round” leakage will most likely occur since the outer surface of the seal ring will not make complete contact with the bore of the housing. As discussed above, machining a gap into a seal ring wherein some of the seal ring material is actually removed, results in lack of true roundness and an inability to completely close the gap when the opposing faces are brought back into contact with each other as shown in FIG. 2.

Furthermore, certain physical properties are important in a seal ring. Properties of particular importance are tensile strength, modulus and elongation. Although metal seal rings tend to have better tensile strength and modulus, elongation is higher in polymers. It has been found that for rings of the present invention, tensile strength should be in the range of 9000 to 18000 psi (62.1×10³ to 124.1×10³ kPa), elongation in the range of 2.5 to 10%, and tensile modulus in the range of 310,000 to 750,000 psi (2.14×10⁶ to 5.17×10 kPa). One of ordinary skill in the art would understand that these are merely preferred ranges, but are not limiting. A wide variety of polymers are suitable for use in the seal rings fractured in the present invention. Those that are particularly suitable are polyimide, polyamide, polyester, polyetheretherketone (PEEK), polyamideimide, polyetherimide, polyphenylene sulfide, and polybenzimidazole. If the polymer is a polyimide, it is preferred that it be prepared from at least one diamine and at least one anhydride. Preferred diamines, which can be used, include m-phenylene diamine (MPD), p-phenylene diamine (PPD), oxydianiline (ODA), methylene dianiline (MDA), and toluene diamine (TDA). Preferred anhydrides, which can be used, include benzophenone tetracarboxylic dianhydride (BTDA), biphenyl dianhydride (BPDA), trimellitic anhydride (TMA), pyromellitic dianhydride (PMDA), maleic anhydride (MA), and nadic anhydride (NA).

Preferred polyimides include those prepared from the following combinations of anhydride and diamine: BTDA-MPD, MA-MDA, BTDA-MDA-NA, TMA-MPD & TMA-ODA, BPDA-ODA, BPDA-MPD, BPDA-PPD, BTDA-4,4′-diaminobenzophenone, and BTDA-bis(P-phenoxy)-p,p′-biphenyl. An especially satisfactory polyimide useful in the seal ring of present invention is that prepared from pyromellitic dianhydride and 4,4′-oxydianiline (PMDA-ODA).

The polyimide compositions can also contain a blend of at least one polyimide with at least one other polymer which is melt processible at a temperature of less than about 400° C. and is selected from polyamide and polyester resin and may be present in a concentration of from about 45 to 79.9 weight percent. Melt processible is used in its conventional sense, that the polymer can be processed in extrusion apparatus at the indicated temperatures without substantial degradation of the polymer.

A wide variety of polyamides and/or polyesters can be used in the present invention and/or can be blended with polyimides. For example, polyamides, which can be used, include nylon 6, nylon 6,6, nylon 610 and nylon 612. Polyesters, which can be used, include polybutylene terepthalate and polyethylene terepthalate.

A fusible or melt processible polyamide or polyester can additionally be, in the form of a liquid crystal polymer (LCP). LCP's are generally polyesters, including, but not limited to polyesteramides and polyesterimides LCP's are described by Jackson et al., for example, in U.S. Pat. Nos. 4,169,933, 4,242,496 and 4,238,600, as well as in “Liquid Crystal Polymers: VI Liquid Crystalline Polyesters of Substituted Hydroquinones.”

The polymers of the seal rings used in the present invention can further include other additives, fillers and dry lubricants, which do not depreciate the overall characteristics of the finished seal rings, as, would be evident to those skilled in the art. For example, the incorporation of graphite into the composition can extend the range of its utility as a wear resistant material. Another beneficial additive is carbon fiber, for the purpose of reducing coefficient of thermal expansion. Various inorganic fillers are known to reduce the coefficient of friction and improve wear resistance. The filler used should not prevent the fracturing of the seal ring in the present invention.

The pocket system of the present invention is advantageous over the prior art ('649). In the prior art three pin method, the two supporting pins must retract or the ring must be lifted onto or off of the pins. In the present invention, a holding member containing multiple recessed pockets can be positioned on a rotating surface or the holding member itself can be rotated. The solid blank rings can be dispensed into an empty recessed pocket, indexed to a fracturing position, i.e., rotated such that the fracturing member can be guided radially inward to each seal ring in turn and then further indexed for quality analysis and packaging. The means for rotating the holding member can be any of the well-known ways for mechanically rotating a solid article. An apparatus such as the present invention is capable of very high production rates, less complicated due to fewer moving and total parts, and adaptable to different ring sizes with little or no modification.

It is claimed:

1. A process for fracturing a seal ring comprising:
a) placing said seal ring having a circumference in a horizontal recessed area of a holding member, wherein the horizontal recessed area has a depth (h) thereby providing a wall having a height equal to depth (h) surrounding the horizontal recessed area and wherein said wall restricts the outward deflection of said circumference, said seal ring is loosely held in said horizontal recessed area and the weight of said seal ring is supported by said horizontal recessed area, whereby said horizontal recessed area and said wall provide three-dimensional support and constraint for said seal ring; and
b) deflecting sharply radially inward a singular localized point on said circumference of said seal ring with a fracturing member, thereby deflecting sharply inward a portion of the seal ring until the force applied by said fracturing member overstresses said seal ring and said fracturing member fractures said seal ring.

2. A process according to claim 1, wherein said horizontal recessed area has a circular shape.

3. A process according to claim 1, wherein said horizontal recessed area includes a portion having an angular shape.

4. A process according to claim 3, wherein said angular shape is a “V” shape.

5. A process according to claim 1, wherein said fracturing member having two opposite ends comprises a fracturing tip with a support member on one end of the fracturing member.

6. A process according to claim 5, wherein said fracturing tip has a radius ranging from 0.015 inches to 0.050 inches.

7. A process according to claim 5, wherein said support member is triangular or oval in shape.

8. An apparatus for fracturing a seal ring comprising:
a) a holding member containing a horizontal recessed area with a depth (h) thereby providing a wall having a height equal to depth (h) surrounding the horizontal recessed area, wherein said seal ring with a circumference, an outside diameter (d) and a thickness (t) is held within and its weight is supported by said horizontal recessed area and wherein outward deflection of said circumference of said seal ring is restricted by said wall, whereby said horizontal recessed area and said wall provide three-dimensional support and constraint for said seal ring; and
b) a fracturing member, wherein said fracturing member is positioned to deflect sharply inward a portion of said seal ring and thereby fracture said seal ring.

9. An apparatus according to claim 8, wherein said fracturing member comprises a fracturing tip on one end of said fracturing member; said fracturing tip contacting the circumference of the seal ring to fracture the seal ring.

10. An apparatus according to claim 8, wherein said height (h) of said wall surrounding said horizontal recessed area is at least one-half the thickness (t) of said seal ring.

11. An apparatus according to claim 8, wherein when said seal ring has an outside diameter (d) of 4 inches or less, said wall surrounding said horizontal recessed area has a height (h) of at least 0.05 inches.

12. An apparatus according to claim 11, wherein when said seal ring has an outside diameter (d) of 4 inches or less, said wall surrounding said horizontal recessed area has a height of at least 0.100 inches.

13. An apparatus according claim 8, wherein said horizontal recessed area has a circular shape.

14. An apparatus according to claim 8, wherein said horizontal recessed area includes a portion having an angular shape and said portion having an angular shape restricts said outward deflection of said circumference of said seal ring.

15. An apparatus according to claim 14, wherein said angular shape is a “V” shape.

16. An apparatus for fracturing seal rings comprising:
a) a holding member containing multiple horizontal recessed areas, wherein each said horizontal recessed area has a depth (h) thereby providing a wall having a height equal to depth (h) surrounding the horizontal recessed area, wherein a seal ring with a circumference, an outside diameter (d) and a thickness (t) is held within and its weight is supported by said horizontal recessed area and wherein outward deflection of said circumference of said seal ring is restricted by said wall, whereby said horizontal recessed area and said wall provide three-dimensional support and constraint for said seal ring;
b) a fracturing member, wherein said fracturing member is positioned to deflect sharply inward a portion of a seal ring and fracture said seal ring and wherein said holding member is rotated so that each seal ring in the holding member, in turn, is rotated to a fracturing position; and
c) means for rotating the holding member so that each said seal ring is positioned in turn with respect to the fracturing member such that the fracturing member can be guided radially inward to said each seal ring.
